(19) United States
(12) Patent Application Publication
(10) Pub. No.: US 2006/0206409 A1
(43) Pub. Date: Sep. 14, 2006

(54) Bid system

(76) Inventor: Elbert Harris, Leawood, KS (US)

Correspondence Address: Entrepreneurial Studies and Development;CMSU, Dockery Suite 102, Warrensburg, MO, 64093, US

(21) Appl. No.: 11/370,343

(22) Filed: Mar. 8, 2006

Related U.S. Application Data
(60) Provisional application No. 60/661,397, filed on Mar. 14, 2005.

(51) Int. Cl. G06Q 40/00

(52) U.S. Cl. 705/37

(57) ABSTRACT

A system and method for receiving bids over a computer network including the steps of creating a bid request that is accessible over a network such as the Internet. Posting the bid request on a computer network, and receiving sealed electronic bids over the computer network. Storing the sealed bids unopened until a specified time, and essentially simultaneously opening all the sealed bids at an electronic bid opening accessible to bidders via said computer network.

### RELATED APPLICATIONS This application claims priority to provisional application 60/661,397.

### BACKGROUND OF THE INVENTION

In various industries it is often desirable to conduct a public request for bids. This can occur when a government entity wants to get bids from various contractors to conduct work on a project such as a construction project for example. Public bids can also be solicited for the purchase of items. There are various methods of taking bids. One common method is to place a request for bids, giving a date when the bids are due. The resulting bids from bidders are held in secret, unopened, until the date and time when the bids are due. Then there can be a public bid opening. With large projects such as the construction of a building, several contractors may attend the bid opening and may wish to inspect bid documents from some or all bidders. A critical aspect of this bid taking process is that all bids are held unopened and in secret. If the bid requester opened some of the bids pre-maturely the contents of those bids could be used to give unfair advantage to one bidder for example.

Patent application 2002/0065760 discloses a sealed bid system for use with a computer network. In this auction system the bids can be manually or automatically opened. The system then allows the person who has placed the bid request, in this patent the ‘trader’, to inspect all bids and to act upon the bids. The problem here is that the trader could contact one or several of the bidders and work with them to alter the result. This may be acceptable and even desired in some bid situations, but is not acceptable in public bids having a public opening.

As can be seen there is a need for a bid system that will allow bids to be taken over a network such as the Internet. There is a need for a bid system that will provide to the bidders proof that the bid opening is being conducted in a way that gives all bidders equal opportunity and where there is a minimum of opportunity to unfairly manipulate the bid process in favor of one bidder. There is a need for a fair bid opening process that does not require a bidder to travel to a remote location to be present at a public bid opening.

### SUMMARY OF THE INVENTION

An aspect of the invention includes receiving bids over a computer network including the steps of creating a bid request and posting the bid request on a computer network such as on a website on the Internet. The system then receives sealed electronic bids over the computer network and stores the sealed bids unopened until a specified time. The system then essentially simultaneously opens all the sealed bids at an electronic bid opening accessible to bidders via the computer network.

These and other advantages of the present invention will become apparent from the detailed description of the invention.

### BRIEF DESCRIPTION OF THE DRAWINGS

FIG. 1 shows a flow diagram of the bid system of the present invention,

FIG. 2 shows a screen shot of the bid opening screen, and

FIG. 3 shows a network over which the current system can operate.

### DETAILED DESCRIPTION OF THE DEVICE

There are a variety of bid systems used in allowing bidders to make an offer either to purchase an item or to provide a service for example.

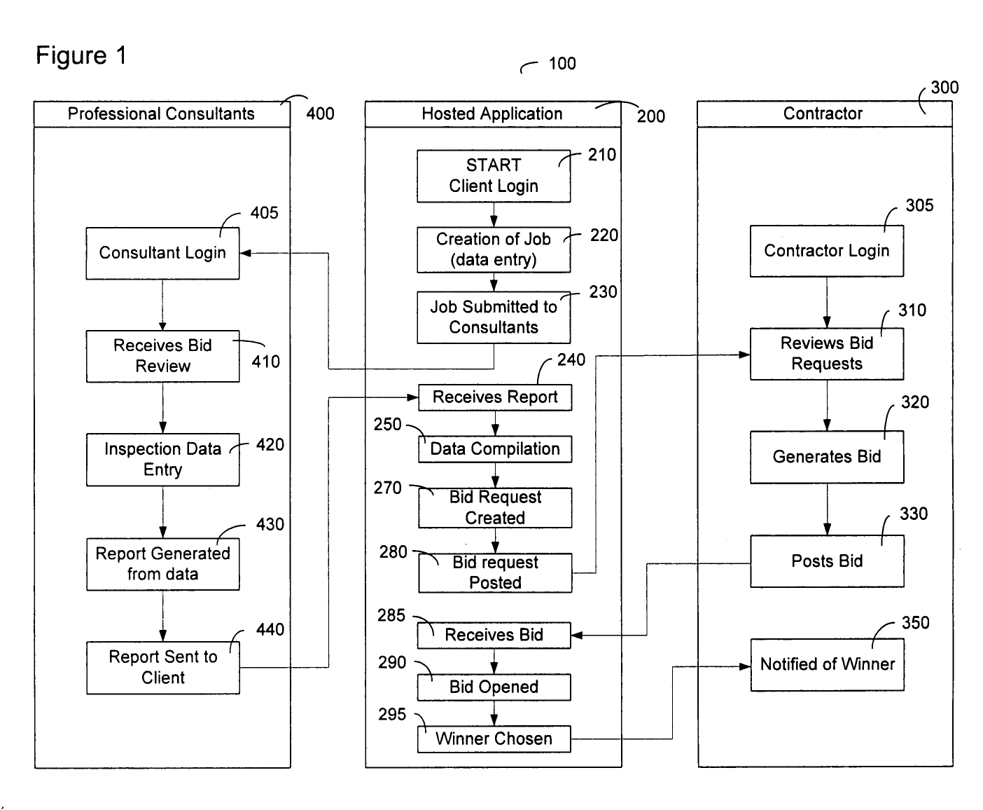

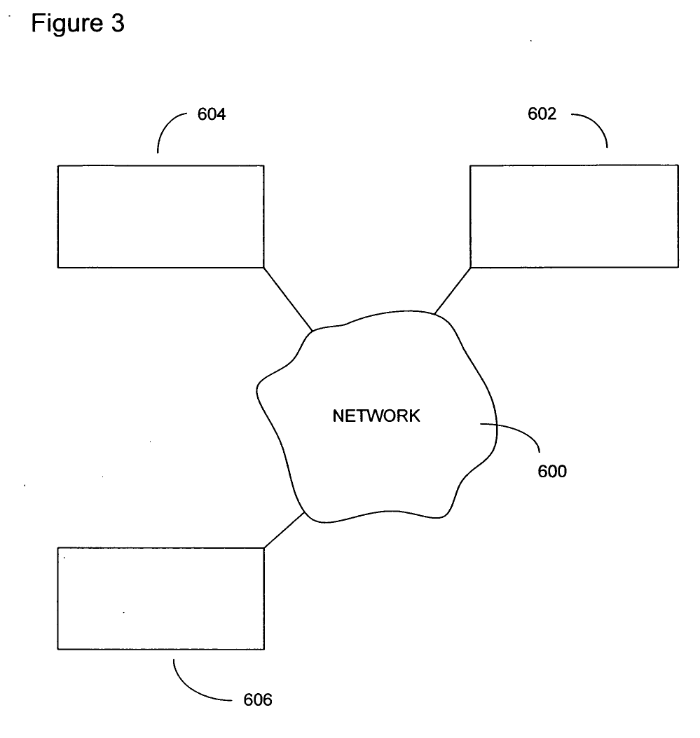

FIGS. 1 shows a flow chart of the hosted bid process 100. The example bid process 100 can include a computer based client process 200 from which a computer network based request for bid can flow and a computer based contractor process 300 from which a bid will be generated. The bid process 100 can also include a bid consultant process 400. The bid process 100 will typically include a specific time that all bidders are aware of for a bid opening. The bid process 100 will be hosted. That is to say the software required to perform the process is primarily resident on an independent network server computer (602 in FIG. 3). The bid requester, contractors and consultants involved in the process do not need special software loaded on their computers (604,606 in FIG. 3). The bid requester is the entity with a project or item to be bid upon.

The bid requester bid process 200 includes a bid requester login step 210 to the hosted website that begins the bid process 200. The bid requester can login 210 to a computer network (600 FIG. 3) based bid generation application hosted on a network server computer (602 in FIG. 3). For example, a web page may be posted on the Internet that would allow a bid requester to create a bid request. Once the bid requester login step 210 is complete, then the bid requester can actually create 220 a bid request. A bid request could for example, include the particulars of a project to be performed. Specifics about the project such as the worksite and delivery dates could be included in a bid request or an electronic attachment containing this information could be attached to the bid request. The electronic attachment could contain information a bidder might want such as job specifications and drawings. The bid request will also contain the specific date and time when the bid opening will occur. In this bid process 100 the bid opening will occur over the network (600 in FIG. 3) such that bidders need not travel to attend the bid opening.

Once the bid request create 220 step is complete the bid requester can submit 230 the bid request to the consultant process 400. The purpose of the consultant process 400 is to make sure that the bid request meets standards for completeness and accuracy. The consultant process 400 could also check for meeting certain regulatory requirements or for other specifics depending upon the field of application. A consultant can login 405 and receive the bid request 410. The consultant can then inspect data entry 420 based on completeness or based on other specific parameters and regulatory requirements. For example, the bid requester could be a university wanting to request bids to build a new university building and the consultant could be a law firm or legal department of the university that would review the bid request to make sure that it meets the legal requirements that a university must meet in requesting bids for a building project.

After inspecting data entry 420 the professional consultant can generate a report 430 on their findings and send report 440 back to the bid requester. Although the consultant process is shown as a separate flow, it will be understood that it could be part of the same flow conducted at the same time as the first three steps 210-230 of the bid requester bid process 200.

The bid requester can receive a report 240 back from the consulting process 400 and compile data 250 from the report to create the final bid request 270. Then the final bid request can be posted 280 on a network N such as the Internet for example so that contractor bidders can provide bids on the request.

The contractor bidder process 300 can begin with a contractor login 305 to the hosted website. Upon login, the contractor can discover that a bid request has been posted 280 and the contractor can review the bid request 310. The contractor can then generate a bid 320 based on the request and then the contractor can post the bid 300 by sending the bid to the bid requester computer. Typically, the post bid step can occur by emailing the bid to the independent hosted website or by creating the bid using the hosted site. The bid can be marked in some way such that it will be recognized as a sealed bid and will not be opened until the official bid open date as specified in the original request for bid. The bid will be received by the host site and will remain sealed and unavailable to the bid requester until the opening. The contractor bidder could submit addendums to the bid or cancel the bid after it is submitted based on the rules of the bid process.

The bid opening 290 occurs on a date as specified in the original bid request. The bid opening is an event conducted by the website host and open to the bid requester and to all contractor bidders who have bid. The bid requester and all bidders will gain access to all bids as they are opened electronically over the network. The bids can be electronically opened essentially simultaneously, at least within one minute or less of each other or within the capability of a given computer system. The simultaneous opening would prevent any favoritism or manipulation of the bid result. The bid requester can then select a winning bid 295 and notify the winner 350.

The entire bid process 100 as shown in FIG. 1 could occur at a hosted network site such as an Internet website, where the bid requester and contractor would complete Internet assessable forms, or the process 100 could occur at a hosted website where the bid requester and contractor could submit electronically forms that they have developed on their computer, following any recommendations made to conform with requirements of the bid request.

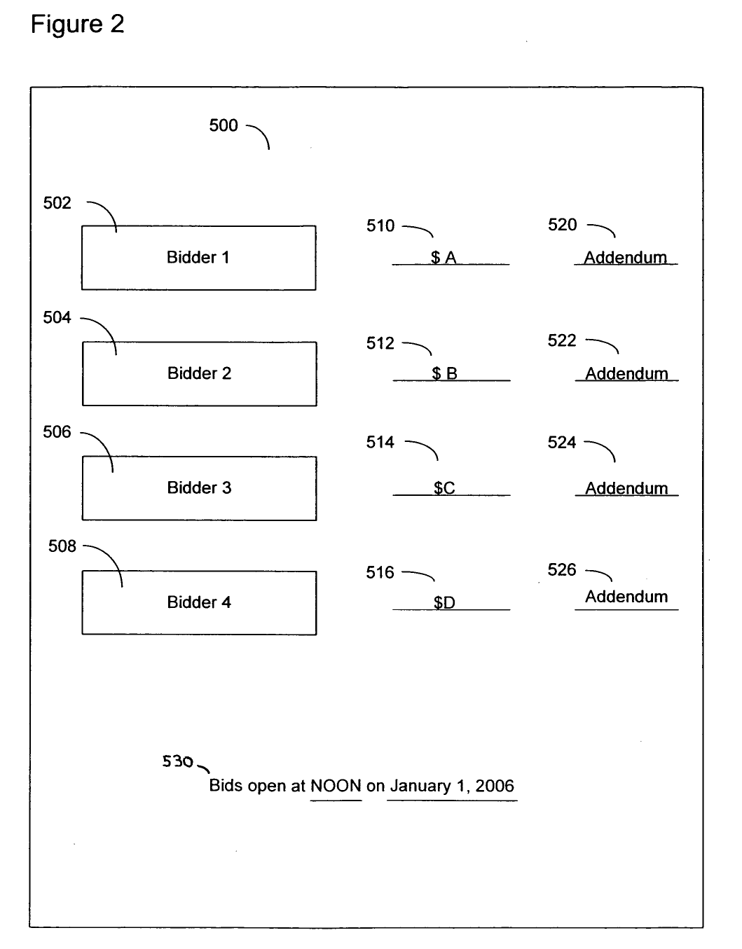

FIG. 2 shows a screen shot of the bid opening 500. The screen can include a list of all bidders 502,504,506,508. The screen 500, can include the bids 510,512,514 and 516 given by the bidders. The bid opening screen 500 can also include any addendums 520,522,524,526 that the particular bidders may have placed in their bids. The addendums 520,522,524,526 are links to any additional material that particular bidders may have included. The material placed in these links are likely to vary depending upon the rules of a particular bid, but material placed in the addendum links would be accessible to all bidders and the bid requester at the bid opening. Just prior to the bid opening the information in screen shot 500 would be blank. There might be a note 530 listing the bid opening time and date. The bids 510, 512, 514, and 516 will be stored on a hosted application. Control of the hosted application is independent of the bid requester and all bidders such that a fair bid process is assured. For example, the hosted application would be owned and controlled by an independent third party.

FIG. 3 shows the relationship of some of the parts of the system. A hosting network server computer 602 can contain a website providing access to the hosted application bid system to a network 600 such as the Internet or other public computer network. A bid requester computer 604 can access the hosted application on network server computer 602 only through the network 600 to post a bid request. Bidder computers 606 can also access the hosted application on network server computer 602 only through the network 600.

While the invention has been described in reference to a preferred embodiment, it is not necessarily limited to the particulars set forth. On the contrary, it is intended to cover such alternatives, modifications and equivalents as set forth in the spirit and scope of the invention as defined by the appended claims.

1. A method for receiving bids over a computer network including the steps of;
creating a bid request,
posting the bid request on a computer network,
receiving sealed electronic bids over said computer network,
storing said sealed bids unopened until a specified time,
essentially simultaneously opening all said sealed bids at an electronic bid opening accessible to bidders via said computer network.

2. The method of claim 1, wherein the step of posting the bid request includes placing information about the bid request on a web site accessible via the Internet.

3. The method of claim 1 wherein a winning bid is selected after said bid opening.

4. A method for processing bids received over a computer network including the steps of;
posting the bid request on a computer network,
receiving sealed electronic bids in a hosted application over said computer network,
storing said sealed bids from a plurality of bidders unopened in said hosted application until a specified time,
simultaneously opening all said sealed bids at an electronic bid opening accessible to bidders via said computer network.

5. The method of claim 4 wherein said bidders have access over said computer network to the bid opening as it occurs such that each of said plurality of bidders have simultaneous access to all sealed electronic bids at the same time during a bid opening.

6. A method for receiving bids over a computer network including the steps of;
creating a bid request on a hosted application,
posting the bid request on a computer network,
receiving sealed electronic bids from bidders over said computer network,
storing said sealed bids unopened until a specified time,
electronically opening all said sealed electronic bids at the same time at an electronic bid opening accessible to bidders via said computer network.

7. The method of claim 6 wherein said bids are posted on said computer network at the same time during a bid opening such that each of a plurality of bidders have simultaneous access to all sealed electronic bid information at the same time during a bid opening.

8. The method of claim 6 wherein said electronic sealed bids are opened at the same time such that the contents of each sealed bid is accessible over a public computer network.

9. The method of claim 6 wherein the sealed bids are simultaneously opened at a bid opening accessible via the Internet.

10. The method of claim 7 wherein the sealed bids are received and stored in an independent hosted application available to said bidders and a bid requester only through the computer network and wherein the computer network is the Internet.
